(19) United States
(12) Patent Application Publication
(10) Pub. No.: US 2012/0259843 A1
(43) Pub. Date: Oct. 11, 2012

(54) DATABASE ACCELERATION USING GPU AND MULTICORE CPU SYSTEMS AND METHODS

(76) Inventor: Timothy Child, San Rafael, CA (US)

(21) Appl. No.: 13/444,778

(22) Filed: Apr. 11, 2012

Related U.S. Application Data
(60) Provisional application No. 61/474,228, filed on Apr. 11, 2011.

(51) Int. Cl. G06F 17/30

(52) U.S. Cl. 707/722; 707/792; 707/769; 707/E17.014; 707/E17.055; 707/E17.141

(57) ABSTRACT

A computer-implemented method for GPU acceleration of a database system, the method includes a) executing a parallelized query against a database using a database server, the parallelized query including an operation using a particular stored procedure available to the database server that includes a GPU/Many-Core Kernel executable; and b) executing the particular stored procedure on one or more GPU/Many-Core devices.

### CROSS REFERENCE TO RELATED APPLICATIONS

This application claims the benefit of U.S. Provisional Application 61/474,228 filed on Apr. 11, 2011, the contents of which are expressly incorporated by reference thereto in its entirety.

### BACKGROUND OF THE INVENTION

The present invention relates generally to GPU and Many-Core programming, and more specifically, but not exclusively, to use of GPU Many-Core Systems programming languages as Stored Procedure languages for databases.

SQL Databases and Non-SQL Databases and Indexed Files Systems (IFS) are used as persistent data stores for a variety of computer applications. Data is stored in tables or files that comprises, of rows or record, which are made up of columns or fields. Each column or field has a specific database type.

Database and Indexed Files systems utilize Stored Procedures or User Defined Functions (UDF). These stored procedures or functions are sub-routines that the database system executes on the data being retrieved by database queries or by API calls. A Stored Procedure or UDF can be written in a variety of languages, including SQL languages like; Transact-SQL, or PL/SQL and other programming languages like C, C++, Java, or a with a GPU programming language.

Graphics Processing Units (GPU) and Many-Core Systems are computer processing units that contain a large number of Arithmetic Logic Units (ALU) or ‘Cores’ processing units. These processing units are capable of being used for massively parallel processing. A GPU may be an independent co-processor or device, or embedded on the same Silicon chip.

GPU and Many-Core devices use specialized programming languages like NVidia's CUDA and the Khronos Organization's OpenCL. These programming languages leverage the parallel processing capabilities of GPU and Many-Core devices. They use Kernels, which are specialized Sub-Routines designed to be run in parallel. To run a Kernel, they require the establishment of a host operating environment to support their execution. They require a compilation and linking phase to convert the source code to machine instructions and link with run-time libraries. At run-time their operating environments load the machine code, transfer data between host environments and run the Kernels. Kernels are declared like sub-routines. They use various programming language data types as arguments.

With the increasing growth of so called “BigDataApplications” there is a need to process even more data at faster speeds with more complex analytical algorithms. Much of the data in Information Technology industry is stored in relational databases. One way processing more data in shorter timescales is to perform more calculations and computations in parallel. Database systems have used parallel data I/O for many years. But there have been few systems to utilize parallel computational processing with databases. These systems have used utilize parallel computational processing in a specific manner to solve a narrow set of problems. These systems have typically required that the database programmer create and execute ad hoc methods to characterize and implement a query used in solving these narrow set of problems, sometimes requiring detailed knowledge of GPU code and programming best practices that are outside of the typical knowledge set for database programmers.

What is needed is a generic system and method for processing data stored in database with GPU and Many-Core System in a highly parallelized manner.

### BRIEF SUMMARY OF THE INVENTION

Disclosed is a system and method for processing data stored in database with GPU and Many-Core System in a highly parallelized manner. Embodiments of the present invention improve performance of database operations by using GPU/Many-Core systems and improve performance of GPU/Many-Core systems by using database operations.

The following summary of the invention is provided to facilitate an understanding of some of technical features related to parallelization of database systems that utilizes GPU and Many Core systems, and is not intended to be a full description of the present invention. A full appreciation of the various aspects of the invention can be gained by taking the entire specification, claims, drawings, and abstract as a whole. The present invention is applicable to other GPU and Many Core programming.

A GPU accelerated database system for a database storing a database table includes an application producing a parallelized query for the database; a database server executing the parallelized query against the database; a stored procedure function manager that executes a stored procedure; one or more GPU/Many-Core devices, each GPU/Many-Core device including a compute unit having one or more arithmetic logic units executing one or more Kernel instructions and a memory storing data and variables; and a GPU/Many-Core host computationally communicated to the one or more GPU/Many-Core devices, the GPU/Many-Core host creating a computing environment that defines the one or more GPU/Many-Core devices, obtaining a GPU Kernel code executable, and executing the GPU Kernel code executable using the one or more GPU/Many-Core devices; wherein the parallelized query includes a particular stored procedure executed by the stored procedure function manager; wherein the particular stored procedure includes the GPU Kernel code executable; and wherein the stored procedure function manager initiates the executing of the GPU Kernel code executable by the GPU/Many-Core host in response to the particular stored procedure.

A computer-implemented method includes a) creating a GPU/Many-Core environment inside a database server; b) obtaining GPU/Many-Core Kernel programs for a plurality of GPU/Many-Core devices executable by the database server as stored procedures; c) querying the GPU/Many-Core environment to obtain a GPU/Many-Core characterization; and d) presenting the GPU/Many-Core environment as a data structure within the database server.

A computer-implemented method for programming one or more GPU/Many-Core devices, includes a) hosting a GPU/Many-Core program Kernel code executable inside a database available to the database as a stored procedure; and b) executing the GPU/Many-Core program Kernel code executable on the one or more GPU/Many-Core devices by calling a query against the database using a database server and the stored procedure.

A computer-implemented method for GPU acceleration of a database system, the method includes a) executing a parallelized query against a database using a database server, the parallelized query including an operation using a particular stored procedure available to the database server that includes a GPU/Many-Core Kernel executable; and b) executing the particular stored procedure on one or more GPU/Many-Core devices.

A computer program product comprising a computer readable medium carrying program instructions for GPU acceleration of a database system when executed using a computing system, the executed program instructions executing a method, the method including a) executing a parallelized query against a database using a database server, the parallelized query including an operation using a particular stored procedure available to the database server that includes a GPU/Many-Core Kernel executable; and b) executing the particular stored procedure on one or more GPU/Many-Core devices.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates the major components of a GPU Accelerated Database system with the principal data flows between these components;

FIG. 2 illustrates the high level flow charts of the major phases of the system;

FIG. 3 illustrates the steps require to create the memory pools, query and cache the metadata information on the GPU/Many-Core data types;

FIG. 4 illustrates the sequence of operation required to create the environment for running GPU code. It show the steps required to determine the GPU platforms and devices available to the database;

FIG. 5 illustrates how the GPU/Many-Core Stored Procedure are compiled for multiple devices and the results are caches for use during the execution phase;

FIG. 6 illustrates the steps required for the validation of arguments and mapping arguments types between the database Stored Procedure and the GPU/Many-Core program Kernel;

FIG. 7 illustrates how metadata is passed to the Stored Procedure;

FIG. 8 illustrates the sequence of events required to execute the query and return the results;

FIG. 9 illustrates how the method of determining how the number of parallel threads in specified for the procedures execution;

FIG. 10 illustrates how the number threads in determined when using the systems dynamic parallelism method;

FIG. 11 illustrates how a single element array is converted to a scalar return type;

FIG. 12 illustrates how the size of an output argument is determined parametrically;

FIG. 13 illustrates how the environment, platform and device information is queried;

FIG. 14 illustrates how the environment, platform and device information is changed; and

FIG. 15 illustrates a flowchart of a process using GPU Kernel argument buffers as columns in database rows or records in order to combine results from multiples devices or multiple Kernel executions.

### DETAILED DESCRIPTION OF THE INVENTION

Embodiments of the present invention provide a system and method for processing data stored in database with GPU and Many-Core System in a highly parallelized manner. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the context of this patent application, the present invention will be better understood by reference to several specialized terms and concepts. These specialized terms and concepts include: database, GPU/Many-Core device, GPU/Many-Core environment, and stored procedure including GPU/Many-Core program Kernel executable.

Database means a database management system comprised of software programs that manage the creation, maintenance and used of computerized data and will include indexed file systems and the like.

GPU/Many-Core device means a specialized computer processor that is capable of performing many parallel operations, whether in a graphics processor unit, a multicore microprocessor, or the like.

GPU/Many-Core environment means a run-time environment created with a host computer program that provides support for compiling, linking, loading and running GPU/Many Core Kernel Subroutines. It provides a mechanism via APIs to discover and manage a number of GPU/Many-Core device.

GPU/Many-Core Kernel Stored procedure means a database stored procedure or User Defined Function that can be called and run as a sub-routine from a database query, and executes on a GPU/Many Core device.

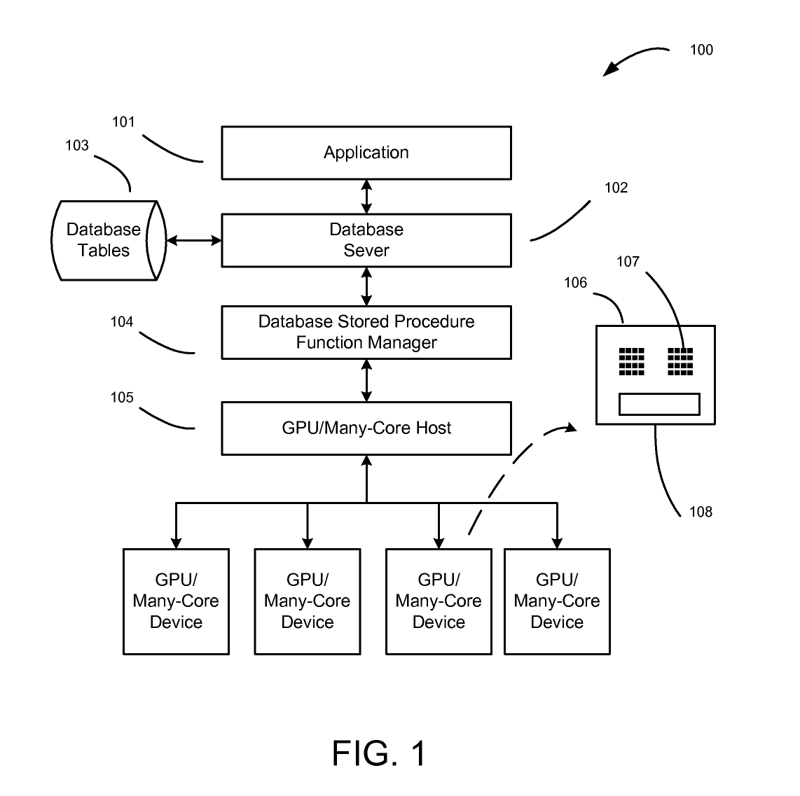

FIG. 1 illustrates a set of components of a GPU accelerated database system along with representation of data flows between this set of components. FIG. 1. includes an illustrative representation of an overall architecture of a GPU accelerated database system 100. Database system 100 includes a number of components; an application 101 that runs queries against a database, a database server 102 that executes the queries, one or more database tables 103 that store persistent database information, a database stored procedure function manager 104 that is responsible for executing Stored Procedures, a GPU/Many-Core Host 105 that creates an environment that defines one or more host platforms and devices, compiles and links GPU Kernel code and runs GPU Kernel code on one or more GPU devices accessible to database system 100. One or more GPU/Many-Core devices 106 are computationally communicated to GPU/Many-Core Host 105, with each GPU/Many-Core device 106 including: a plurality of GPU Compute Units 107, each having one or more Arithmetic Logic Units (ALUs) that execute the Kernel instructions, a GPU memory 108 (e.g., RAM and the like) that stores the GPU's data and variables.

Database system 100 allows a database programmer who is coding a database program/query for use in a parallel environment to access GPU/Many-Core devices using a more familiar database paradigm to allow simpler and more efficient coding and use of these devices. Preferred embodiments of the present invention restructure the conventional ad hoc programming approach into a more efficient GPU paradigm that includes three distinct phases that are uncoupled from other phases. These phases include a configuration phase, a compile phase, and an execution stage. Upon initialization, database system 100 configures itself to enumerate and define the GPU/Many-Core environment. The second phase for database system 100 is compilation/access of any special stored procedures specific for the GPU/Many-Core environment. The third phase includes execution of the code using the stored procedures appropriate for the specific GPU/Many-Core environment. Some of the powerful features of these embodiments include i) storage of GPU/Many-Core environment parameters in a manner that appears as database tables within the database so the programmer may easily dynamically adapt the database code for optimal use of the GPU/Many-Core environment and ii) use of GPU/Many-Core specific code objects within the database as stored procedures. The database programmer is able to efficiently define and use the GPU/Multi-Core environment without many of the challenges associated with the conventional GPU/Many-Core programming model.

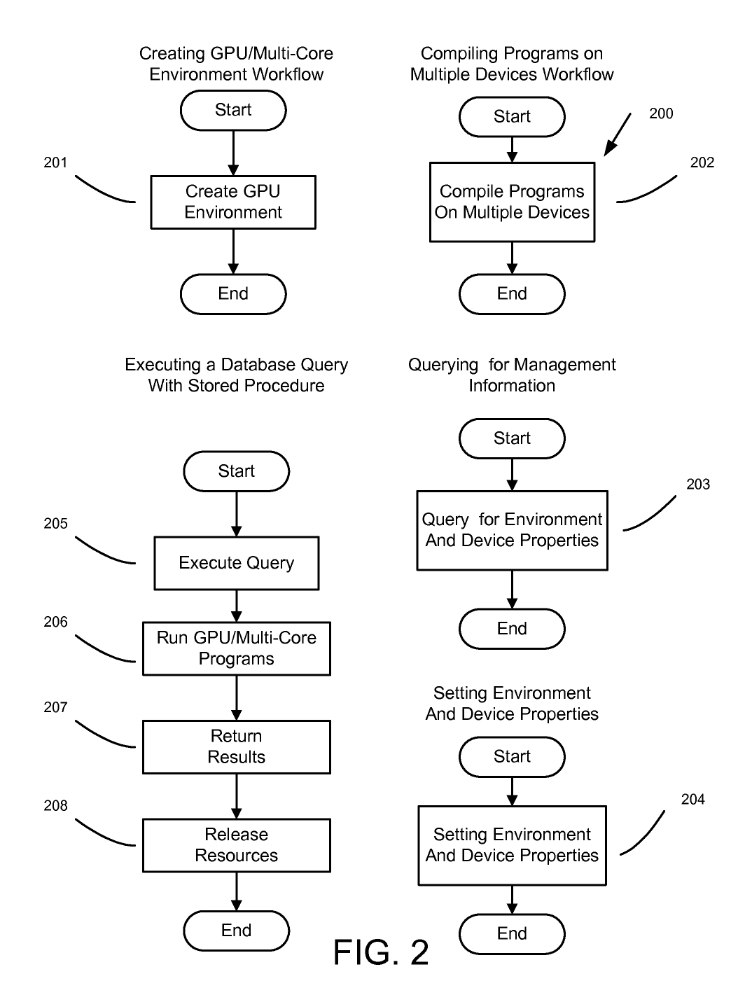

FIG. 2 illustrates high level processes of major phases of database system 100 illustrated in FIG. 1. FIG. 2 represents various high level components 200 and their high level flowcharts. A creating GPU/Many-Core Environment Workflow process include a step 201 to create the GPU/Many-Core Environment inside database server 102. A compiling programs on multiple devices workflow includes a process 202 to obtain (e.g., compile and link or access, such as dynamically linked library or pre-compiled executable) GPU/Many-Core Kernel programs on multiple devices. A querying for environment and device properties workflow includes a process 203 to query the GPU/Many-Core Environment, Platform and Device properties and present the results as database tables or records. A setting environment and device properties workflow includes a process 204 to update or change GPU/Many-Core Environment, Platform and Device properties and present the results as database tables or records.

An executing a database query with stored procedure workflow includes a sequence of processes. A first step 205 in this workflow steps to execute a query with a stored procedure. A second step 206 runs the GPU/Many-Core Kernel code. A third step 207 returns the results as database tables or records to the applications. A fourth step 208 releases any resources that were used in executing the query and running the GPU/Many-Core Kernel code, that are no longer needed.

In some cases, the description refers to “obtaining” a stored procedure or similar general term. This term is specifically used to refer to creation of the stored procedure by compilation and linking of appropriate libraries and the like, as well as access of a precompiled/linked procedure, such as by a predetermined address or reference.

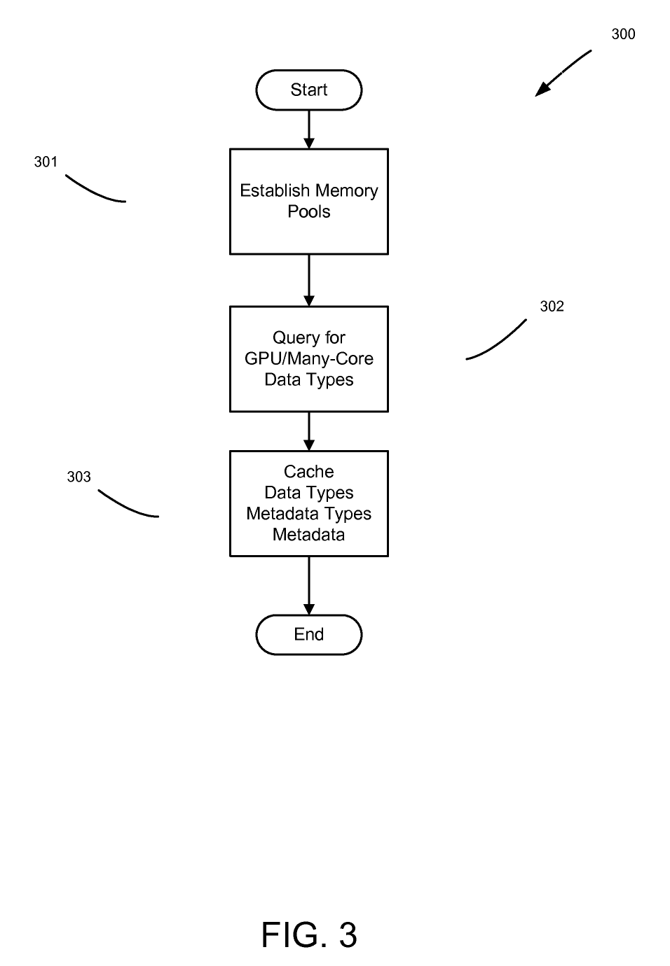

FIG. 3 illustrates a sequence of steps for creation of memory pools, a parallelized query and cache metadata information on the GPU/Many-Core data types. Managing database server 102 and GPU/Many-Core Host 105 environment in compatible and complementary methods is achieved by allocating memory in multiple pools. Memory pools are a technique in managing memory support dynamic memory allocation in fixed sized pools that limits memory fragmentation. Each pool has a specific life that is dependent on the type of object allocated in the pool as further explained in Table I.

TABLE I
A Table Describing Various Memory Pools

| Memory | | |
|---|---|---|
| Pool Name | Description | Pool Object Lifetime |
| Device Pool | Stores object | The pool objects exist whilst |
| | related to the | the database is running. The |
| | GPU Host | pool is de-allocated when the |
| | environment, Platforms, | database stops executing. |
| | Devices, Contexts, | |
| | Queues, metadata | |
| | and various other | |
| | long life objects | |
| Program | Stores the Kernel | The objects are created when a |
| Pool | source and | kernel is compiled or |
| | object codes. | executed. The pools are de- |
| | | allocated when a Kernel |
| | | program is changed or |
| | | recompiled, and a new pool is |
| | | created. |
| Buffer Pool | Stores buffers | A pool is created when a |
| | for Kernel | Kernel is executed. The pool |
| | execution. | is de-allocated after Kernel |
| | | execution completes. |
| Retained | Stores buffers | A pool is created at start up |
| Pools | to be used across | time. The pool is de-allocated |
| | multiple Kernel | when the database stops |
| | executions. | executing. |

FIG. 3. 300 represents a workflow to create the GPU/Many-Core environment, Platform and Devices. A first step 301 establishes one or more memory pools. A second step 302 queries a database system metadata store for information about special types used by the Kernel as metadata and GPU specific data types. A third step caches the metadata for these types in the GPU Host environment for future use during any Kernel compilation and the Kernel execution steps.

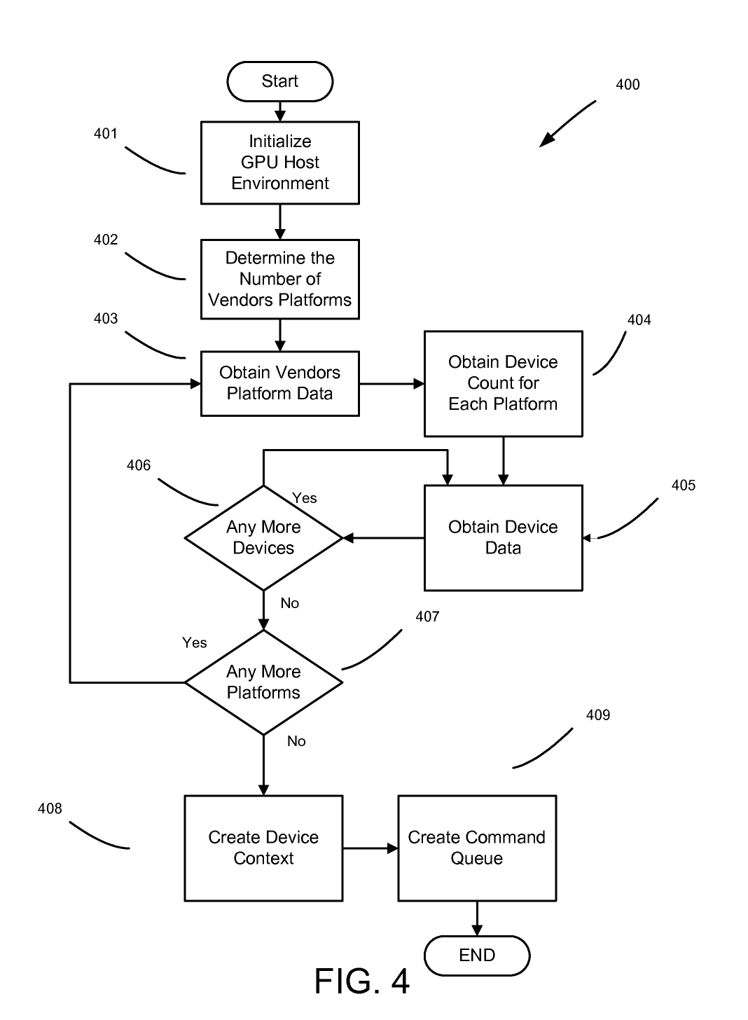

FIG. 4 illustrates a sequence of operation required to create an environment for running GPU code. It represents steps determining the GPU platforms and devices available to database system 100. FIG. 4 is an illustrative flow chart 400 of work flow steps to create GPU/Many-Core Environment, Platform and Devices. A system may include several platforms and devices from one or more vendors.

A first step 401 initialized a GPU/Many-Core host environment and a second step 402 determines a number of vendor platforms. A third step 403 obtains properties of each platform, and a fourth step 404 obtains a count of devices for each platform. A fifth step 405 obtains device data, and a sixth step 406 determines whether there are more devices. If so, process 400 repeats fifth step 405, else a seventh step 407 determines whether there are more vendor platforms to process. If there are, process 400 returns to third step 403 is repeated, otherwise process 400 performs eighth step 408 and creates a memory context for all the devices. Thereafter process 400 concludes with a ninth step 409 which creates a command queue for each device.

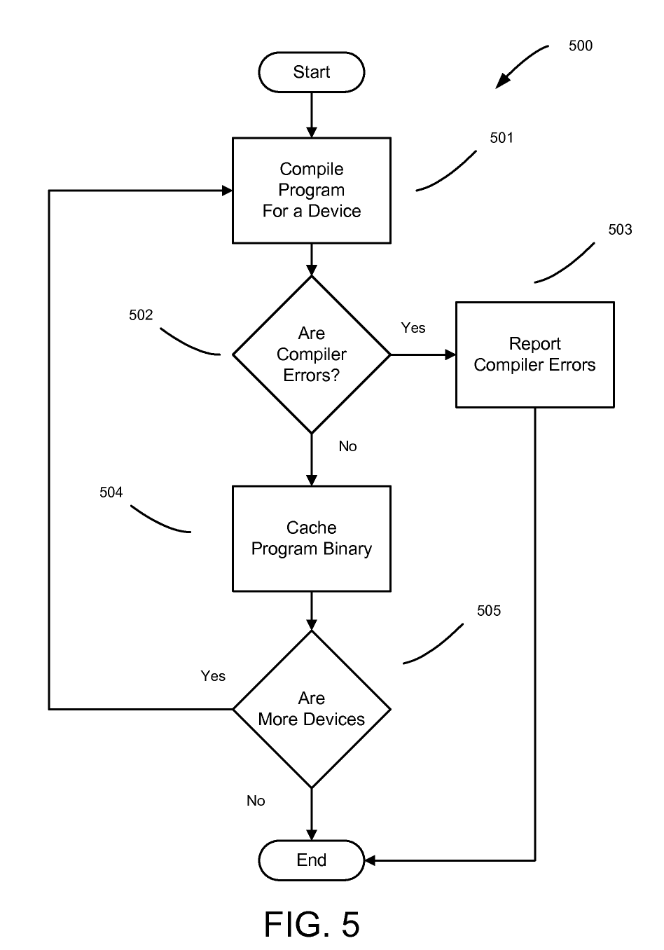

FIG. 5 illustrates how a GPU/Many-Core Stored Procedure is compiled for multiple devices and the results are cached for use during an execution phase. Database system 102 may be able to access many different kinds GPU/Many-Core devices. A GPU Kernel may be run on each kind of device. Kernel code compiled on one device type may not be compatible with another device type. So to avoid the potential problem of having incompatible code, Kernels are compiled for all the different types of devices.

FIG. 5 is an illustrative flowchart 500 of a workflow to compile each kernel program for each device. A first step 501 compiles a program for a particular one device and a second step 502 determines whether there are compilation errors. In case there are errors at second step 502, process 500 performs a third step 503 which reports the errors. When there are no errors at second step 502, a fourth step 504 caches the program binary in the Program Memory Pool. A fifth step 505 determines whether there are more devices the program needs to be compiled against. If so, process 500 returns to first step 501, otherwise this workflow ends.

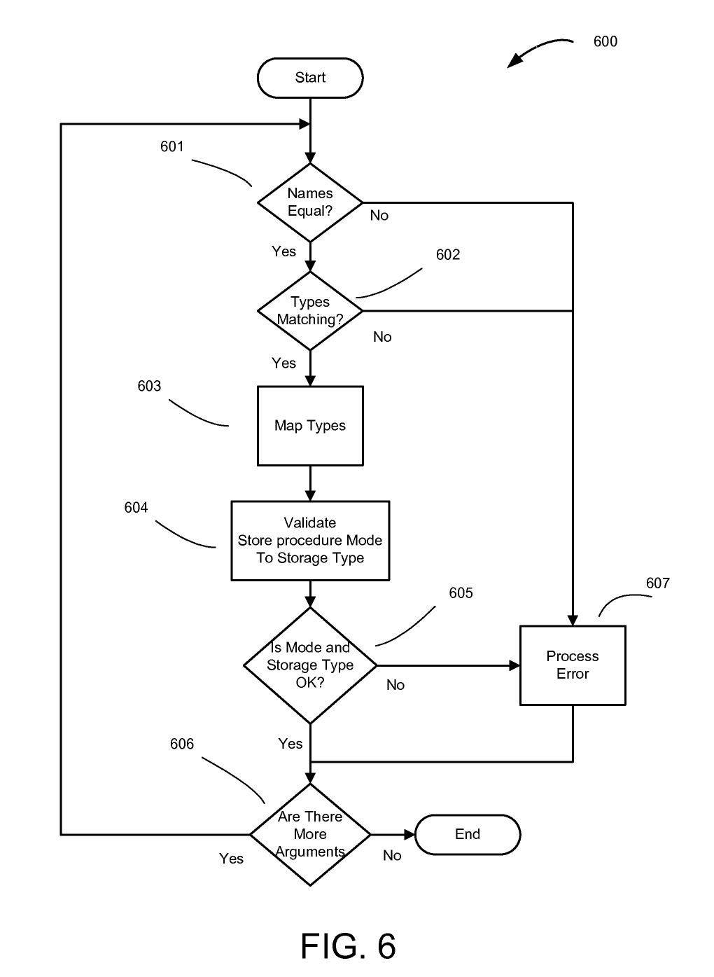

FIG. 6 illustrates validation of arguments and mapping arguments types between a database Stored Procedure and a GPU/Many-Core program Kernel. For each Stored Procedure and GPU kernel there are two types of subroutine call declarations and bindings. One for the database in the database language or API's. One for the GPU/Many-Core Kernel language. Each programming language has its own set of data types and metadata attributes, so in order to prevent errors at run-time when the Stored Procedure calls the GPU Kernel it is necessary to validate arguments to ensure that arguments of the database stored procedure are compatible with the GPU Kernel code.

FIG. 6 is an illustrative flowchart 600 of a process for validating and mapping arguments between database stored procedures and GPU/Many-Core Kernel routines. A first step 601 tests names and positions of the stored procedure arguments for a match. When they are equal, a second step 602 checks that the data types match. When the types match at second step 602, a third step maps the types between the database and the GPU kernel language. Thereafter, a fourth step 604 determines a correspondence of metadata attributes of the arguments and a fifth step 605 determines whether the correspondence is sufficient. When correspondence is sufficient at fifth step 605, a sixth step 606 determines whether there are more arguments to process. When there are more arguments, the process returns to first step 601, with the process concluding when there are no more arguments. When there are errors at first step 601, second step 602 or fifth step 605, the process performs seventh step 607 to reports the error to the system, and then performs the test at sixth step 606.

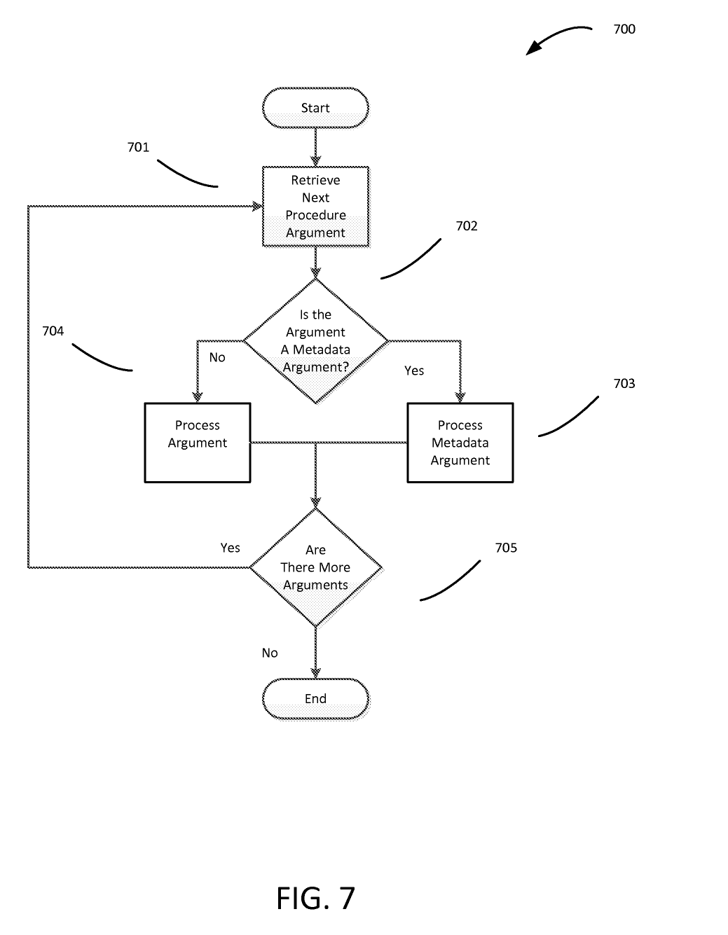

FIG. 7 illustrates how metadata is passed to the Stored Procedure. The database stored procedure declarations use a well-defined standard language or API. The GPU Kernel declaration also uses its own well defined standard language to declare kernel bindings. The use of standard languages and API's constraints the type of information that can be communicated between the two programming languages without extending the language or API. So, in order to communicate additional metadata between the two programming languages metadata types have been developed to communicate meta information at compile and run time.

FIG. 7 is an illustrative flowchart 700 of a process for communicating metadata information between a Stored Procedure declaration and a GPU Kernel declaration. A first step 701 retrieves a next procedure argument, and a second step 702 determines whether the argument's type is a metadata type. When the test at second step 702 determines the type as a metadata type, the process advances to third step 703 where the argument is processed as a metadata type. When the test at second step 702 determines the type is not a metadata type, the process advances to fourth step 704 where the program data argument is processed as a program data argument. After both third step 703 and fourth step 704, the process advances to a fifth step 705 and determines whether there are more arguments to process. If there are more arguments, the process returns to first step 701 and when there are no more arguments, the process concludes.

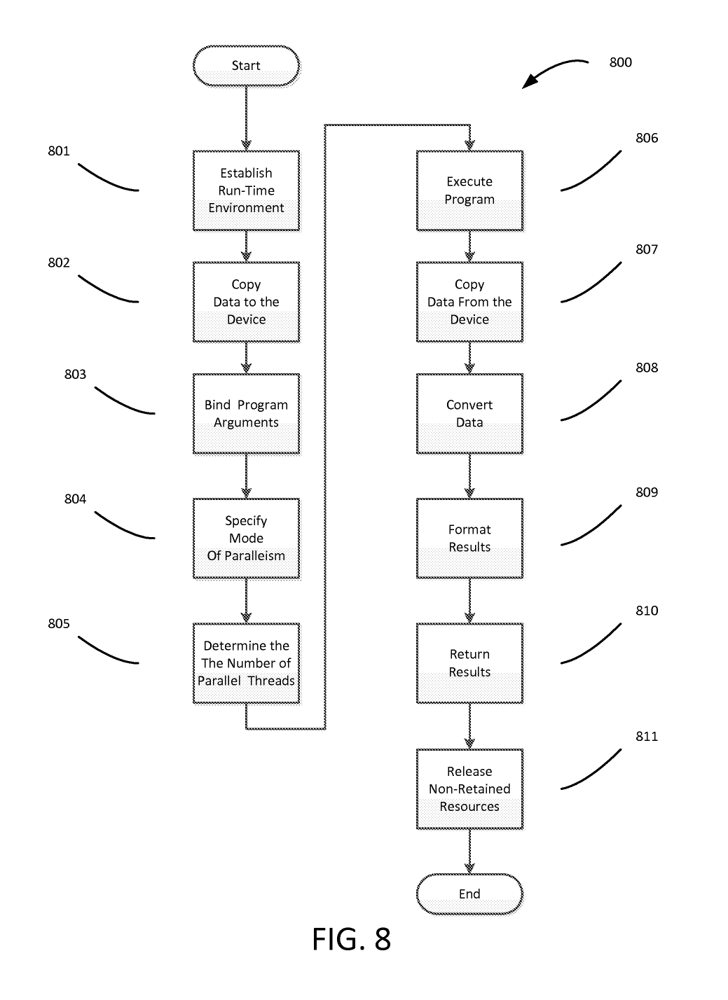

FIG. 8 illustrates a sequence of events to execute a query and return results from the execution of the query. FIG. 8 is an illustrative flowchart 800 of a process executing a database stored procedure query and returning the results to the calling application. The sequence of events includes steps 801-811. A step 801 establishes a run-time environment for database system 100, a step 802 copies or transfers data from the database to a GPU device, a step 803 binds the program arguments for the copied data, and a step 804 determines how the mode of parallelism is defined. A step 805 determines a number of parallel threads to be used, a step 806 executes a Kernel on the GPU device, a step 807 copies or transfers data from the GPU device to the Host, and a step 808 converts the data to database types. A step 809 formats the data for the database, a step 810 returns the results as database rows or records to the application, and a step 811 releases resources that are not to be retained for a future execution.

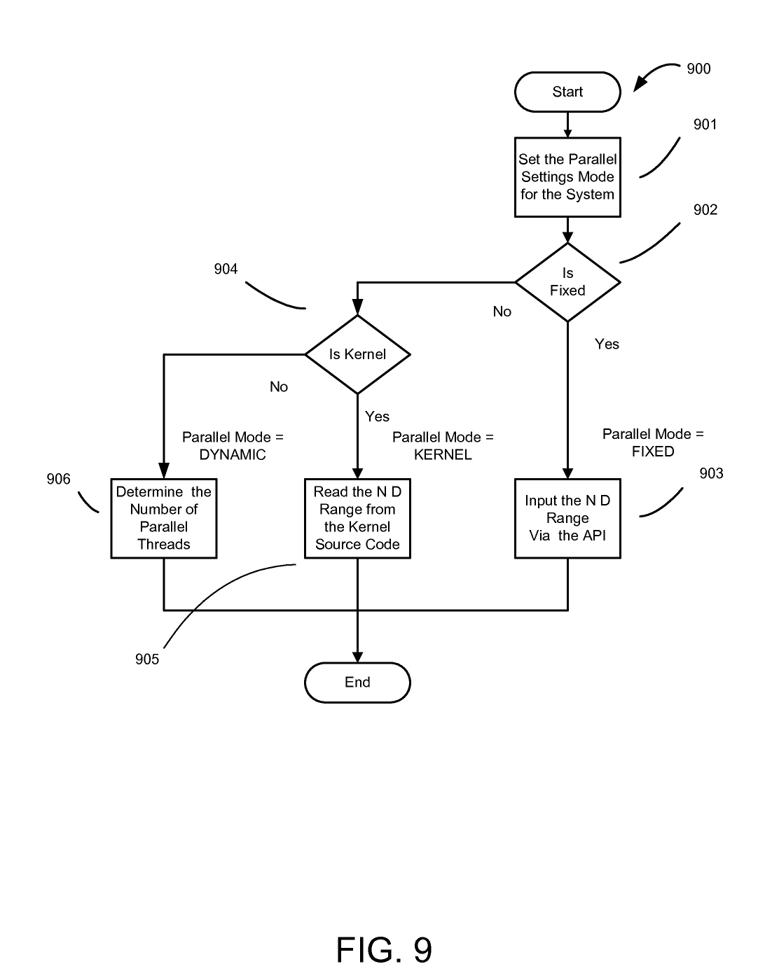

FIG. 9 illustrates how a process determining how a number of parallel threads is specified for execution. GPU/Many-Core devices are massively parallel device that may incorporate from 32 to 2000 ALU cores. A particular number of these cores used for program execution is determined by a number of parallel Kernel threads launched. The number of threads can be determined in a number of ways. Embodiments of the present invention specify three ways of controlling the number thread used as described in Table II. The choice of method is specified via an API call that can be used from the database.

TABLE II
A Table of Parallel Mode Settings

| Name | Description |
|---|---|
| FIXED | The number of threads used |
| | will be constant. It's specified |
| | via an API call. |
| KERNEL | The number of threads used |
| | will be constant. It's specified |
| | in the Kernel source code. |
| DYNAMIC | The Database will determine |
| | the number threads based on |
| | inspection of the Kernel |
| | arguments sizes and meta data |
| | provided to the Kernel. |

FIG. 9 is an illustrative flowchart 900 of a process for controlling determination of the number of parallel threads. Flowchart 900 includes steps 901-906. Step 901 sets the mode and step 902 determines whether the parallel mode setting is “FIXED.” When it is, the process performs step 903 where the number of threads (N-dimensional range) is specified via an API. When the test at step 902 determines the mode is not FIXED, the process tests whether the parallel mode setting is “KERNEL” at step 904, and then a step 905 specifies the number of threads (N-dimensional range) from the Kernel source code. When the test at step 904 does not determine that the parallel mode setting is “KERNEL” then the parallel mode setting is “DYNAMIC” and the process performs a step 906 where the number of threads is determined by the database. After any of steps 903, 905, and 906, the process concludes.

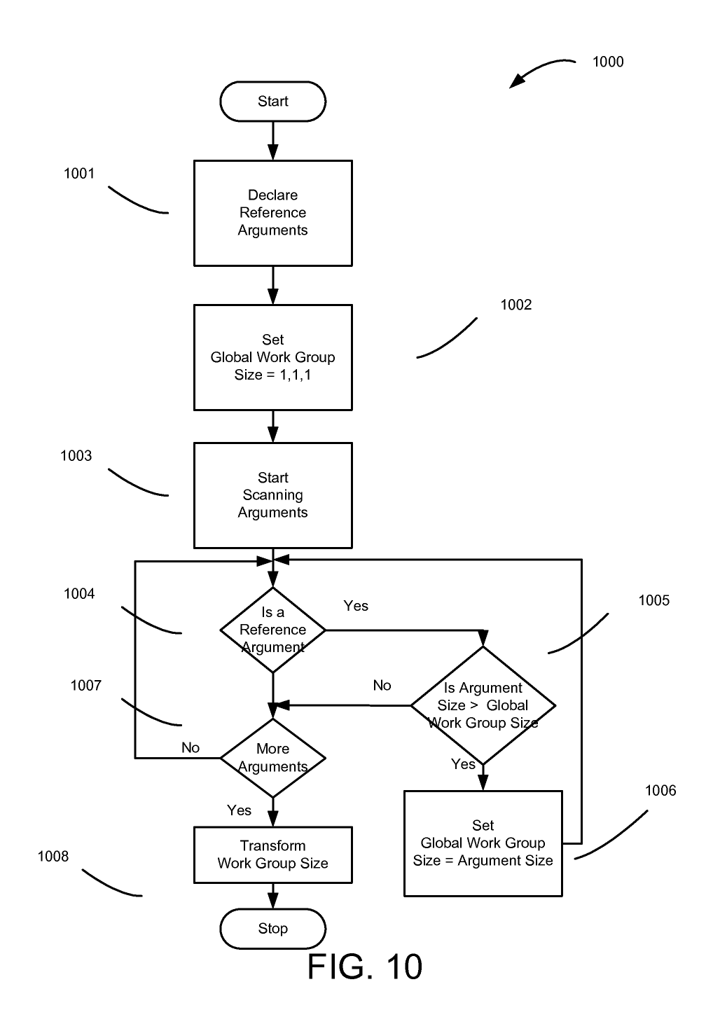

FIG. 10 illustrates how a number threads is determined when using the system's “DYNAMIC” parallelism method described in FIG. 9. GPU/Many-Core systems have a model of thread execution that maps the threads into 1D, 2D, or 3D arrays of threads. In the OpenCL GPU programming language these are called Work Groups. The number of threads is specified by the number of dimensions (1, 2, or 3) and the size of each dimension in the X, Y, Z direction. When the Parallel Thread mode is ‘DYNAMIC’ the database will determine the number of parallel threads based of the argument mode and metadata provided to the Kernel function.

TABLE III
Stored procedures and Kernel arguments have one
of three usage modes.

| | | Usage in Determining the |
|---|---|---|
| | | Number of Parallel |
| Mode Name | Description | Threads |
| INPUT | The argument is exclusively | The argument can be a |
| | used as an input parameter. | reference variable for |
| | | determining the number of |
| | | parallel threads. |
| OUTPUT | The argument is exclusively | The argument cannot be a |
| | used as an output parameter. | reference variable for |
| | | determining the number of |
| | | parallel threads. |
| INOUT | The argument is used as | The argument can be a |
| | both an input and an output | reference variable for |
| | parameter. | determining the number of |
| | | parallel threads. |

Kernel arguments are either scalar, vectors arrays or images types. Each argument has a characteristic number of elements for each dimension, the database determines the “DYNAMIC” thread size by using the Kernel argument elements size, and metadata. The metadata includes a set of linear transformation in either 1D, 2D, or 3D corresponding to the number of Work Group dimensions applied to the reference arguments element sizes.

FIG. 10 is an illustrative flowchart 1000 of methods used for dynamically determining the number of parallel threads used for GPU/Many-Core Kernel Execution and includes steps 1001-1008. A step 1001 declares one or more reference arguments, a step 1002 sets a starting Work Group Size to 1, 1, 1 for the X, Y and Z directions, and a step 1003 starts scanning the arguments. A step 1004 determines whether the argument is a reference argument, and if it is, a step 1005 compares each reference argument's elements size in X, Y, Z dimensions to the Work Group Size X, Y, Z dimensions. When the argument elements size is greater than the corresponding Work Group Size, a step 1006 replaces the Work Group Size with the corresponding argument size and the process returns to step 1004. Either when step 1004 determines that the argument is not a reference argument the process or when step 1005 determines that the argument size is not greater than the global work group size, the process performs step 1007 to determine whether there are more arguments to process. When there are no more arguments to process from step 1007, the process returns to step 1004. When there are more arguments to process at step 1007, the process performs step 1008 to transform the Work Group by a metadata transformation parameters matrix. The metadata transformation parameters matrix specify either 1D, 2D or 3D transformations that includes only translation or scaling factors. The process concludes after step 1008.

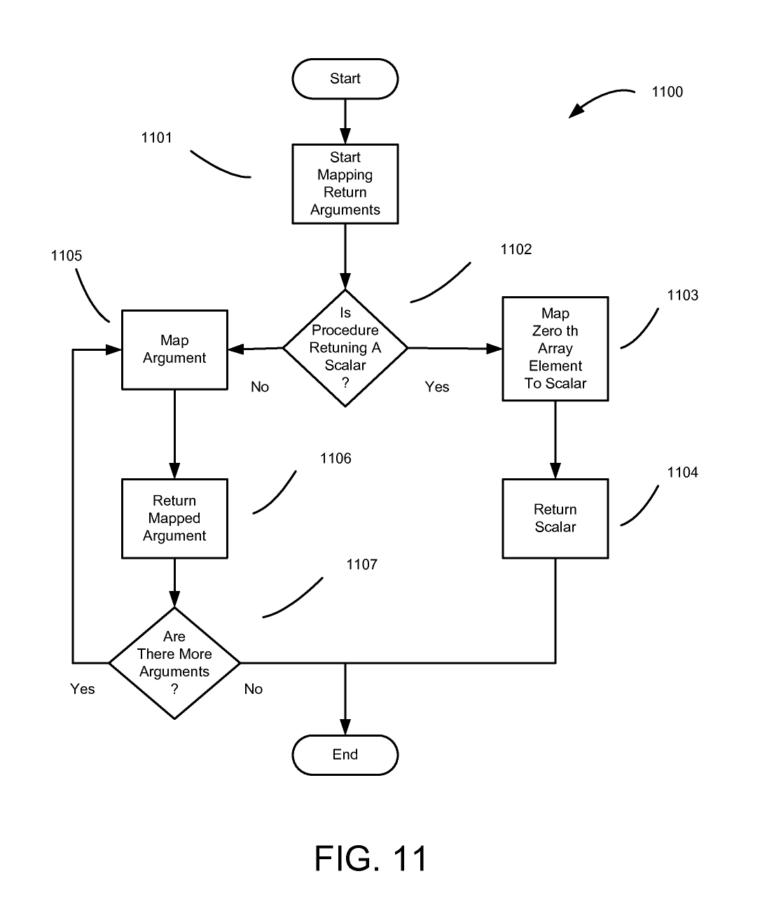

FIG. 11 illustrates how a single element array is converted to a scalar return type. The language standard of GPU/Many-Core kernel functions mandates a void return type. Returning data is passed as a ‘by reference’ argument. Database Stored Procedure languages support both return types and data is passed as a ‘by reference arguments’. Some GPU Kernels execute as parallel reductions, where multiple inputs are aggregated into a single result. To return a single value from many executing threads, there is a programming convention in GPU Kernel code which uses one thread to set a single value in a passed by reference argument array. That is the return value from a parallel reduction. This invention is capable of recognizing this case and automatically maps a single array element value to corresponding database scalar return value.

FIG. 11 represents a process 1100 converting a single element array to a corresponding type and includes steps 1101-1107. A step 1101 starts mapping the return types and a step 1102 determines whether the database Stored Procedure returns a scalar. When step 1102 determines a scalar is returned, process 1100 performs a step 1103 to map the zero-th element in the array to its corresponding scalar and next a step 1104 returns the scalar value. When step 1102 determines a scalar is not returned, process 1100 proceeds to a step 1105 and maps the argument in the normal way. Following step 1105, a step 1106 returns the argument value and a step 1107 determines whether there are more arguments to map. When at step 1107 there are more arguments to map, process 1100 returns to step 1105. Process 1100 concludes after step 1104 and after there are no more arguments at step 1107.

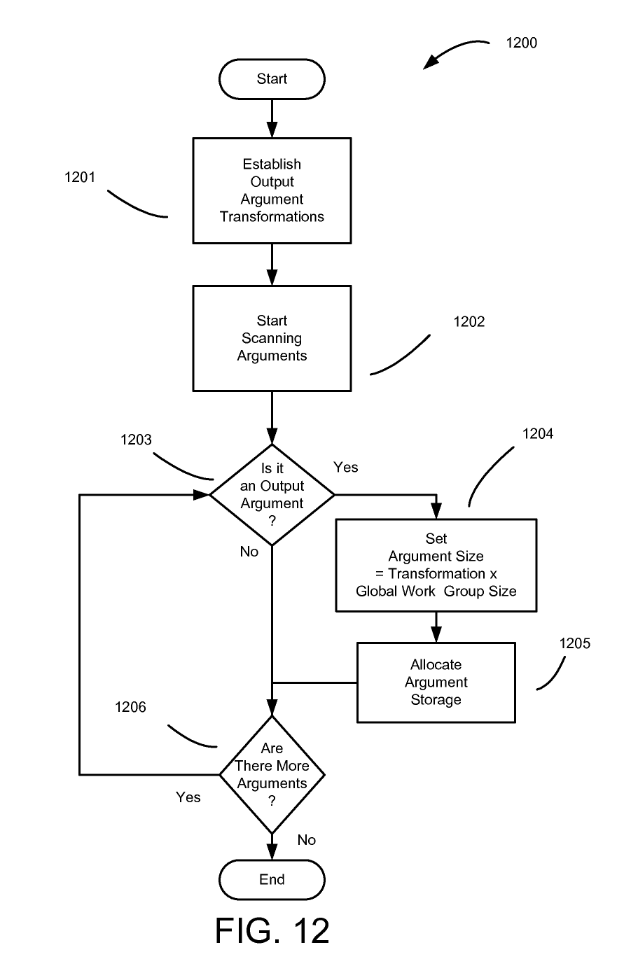

FIG. 12 illustrates how a size of an output argument is determined parametrically. A database is capable of storing many millions data records or rows. Each of these rows could be processed by a GPU/Many-Core Stored Procedure. When the row or database column is non-fixed length, the size of the data to be processed by the Stored Procedure is not known until run-time. GP/Many-Core programming languages don't have any dynamic memory allocation capabilities. Memory must be allocated by the Host environment prior to running the GPU/Many-Core kernel. The size of the arguments data is determined at run-time. For arguments with a mode of INPUT or INOUT, the database has already determined the size of each argument at run-time. It can easily determine the amount of GPU memory to allocate prior to running the GPU Kernel. For OUTPUT mode parameters, the size cannot be determined from the argument as the data has not yet been created prior to running the Kernel. So there is a problem of how to specify the size of an OUTPUT mode parameter for potentially millions or records and GPU Kernel executions?

Some embodiments of this invention uses a parameterized metadata as an argument, to a Stored Procedure, to specify the OUTPUT mode argument size. It uses the Work Group Size dimensions X, Y, Z and applies a corresponding linear transformation to the Work Group Size to scale and translate the OUTPUT mode argument size.

FIG. 12 is an illustrative flowchart 1200 of a process to establish and allocate the memory for an OUTPUT mode parameter and includes steps 1201-1206. A step 1201 establishes the OUTPUT mode argument transformations metadata, a step 1202 starts scanning the Stored Procedure arguments, and a step 1203 determines whether the argument is an OUTPUT argument. When step 1203 determines it is an Output argument, a step 1204 sets the argument size to be the metadata transformation of the Work Group Size and a following step 1205 allocates GPU memory for an argument of that size. When step 1203 determines that the argument is not an output argument, the process advances to a step 1206 to determine whether there are more arguments to process. When there are more arguments at step 1206, the process returns to step 1203, otherwise the process concludes.

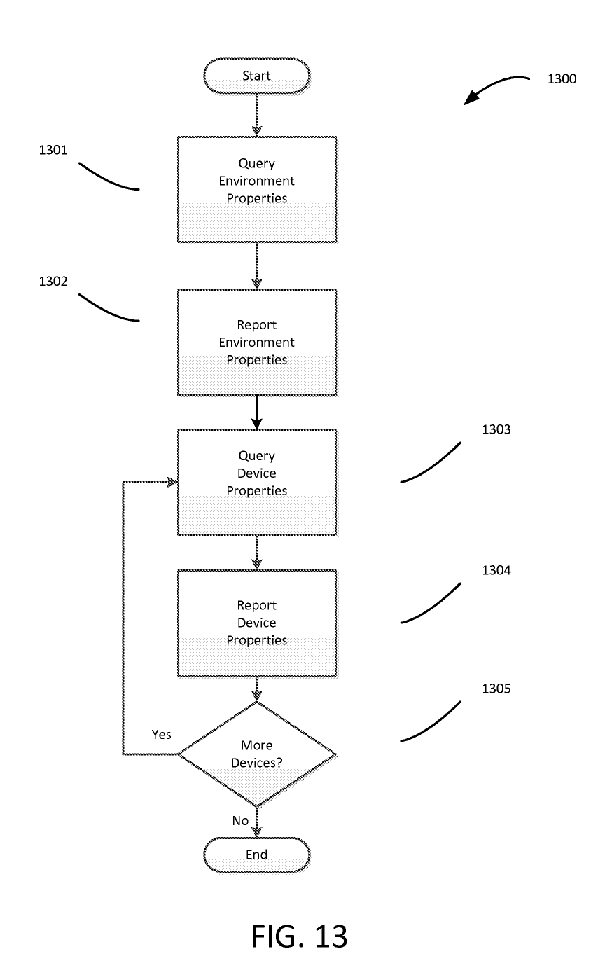

FIG. 13 illustrates how environment, platform and device information is queried. A user or an application needs to know how many, and what kinds or Platforms, Devices and GPU/Many-Core device capabilities are available to database system 100. GPU programming languages have low level APIs that can be used to obtain this information. For a database, this information is best returned as a database row or record. Some embodiments of this invention uses the low-level GPU programming language APIs to create database tables or records to display GPU environment data, Platforms, Devices and GPU/Many-Core device capabilities.

FIG. 13 is an illustrative flowchart 1300 of a process used to query the GPU/Many-Core environment for Platforms, Devices and GPU/Many-Core device capabilities and includes steps 1301-1305. A step 1301 queries the GPU environment for properties. A next step 1302 reports the environment properties as database rows or records, a step 1303 queries the device properties, and a step 1304 reports the device properties as database rows or records. A step 1305 determines whether there are there more devices, and when there are, the process returns to step 1303. Otherwise the process concludes after step 1305.

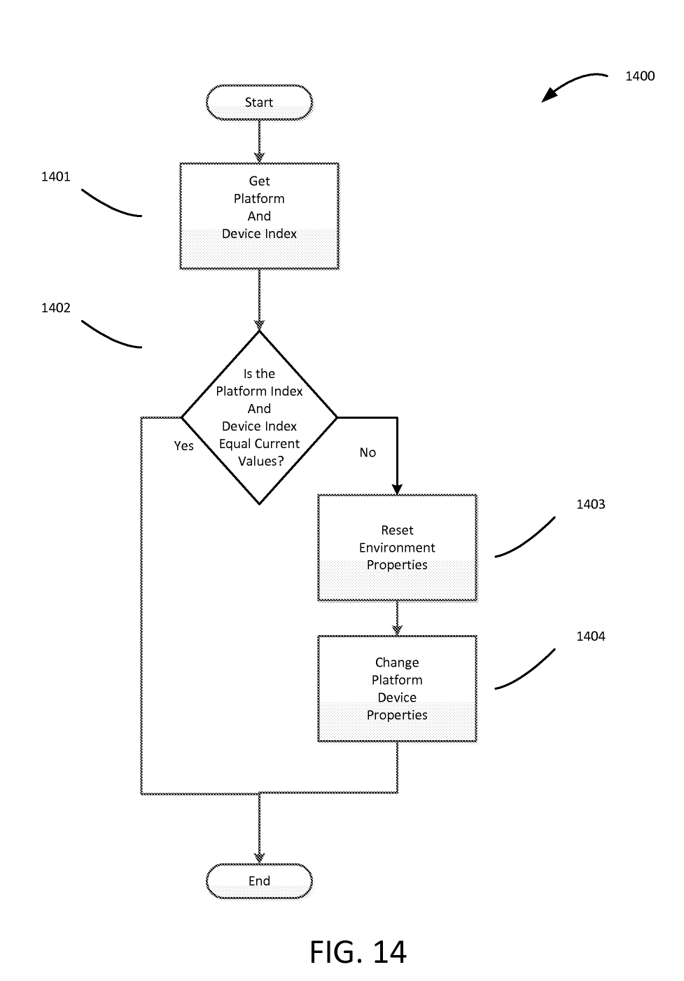

FIG. 14 illustrates how environment, platform and device information is changed. A GPU accelerated database system may have several different vendors platform, multiple devices and each device may have multiple device characteristics. When a user or an application needs to specify, select or change a property of the GPU/Many-Core environment their application must use a low level API to accomplish this.

A database uses Update statements or API calls to change data within their systems. Some embodiments of this inventions use database Update statements and API calls to change the characteristics of the GPU environment, Platform, Device or Device characteristics. This allows the application to issue database queries to select a set of devices and specify which one to use for specific GPU Kernel execution.

FIG. 14 is an illustrative flowchart 1400 of a process for changing the GPU Environment, Platform Device type or Device Characteristics and includes steps 1401-1404. A step 1401 gets a Platform and Device Index and a step 1402 tests whether the Platform and Device Index is equal to the current values. When the test at step 1402 is no, a step 1403 resets the GPU environment and a step 1404 changes the Device properties. The process concludes when the test at step 1402 is yes or after step 1404.

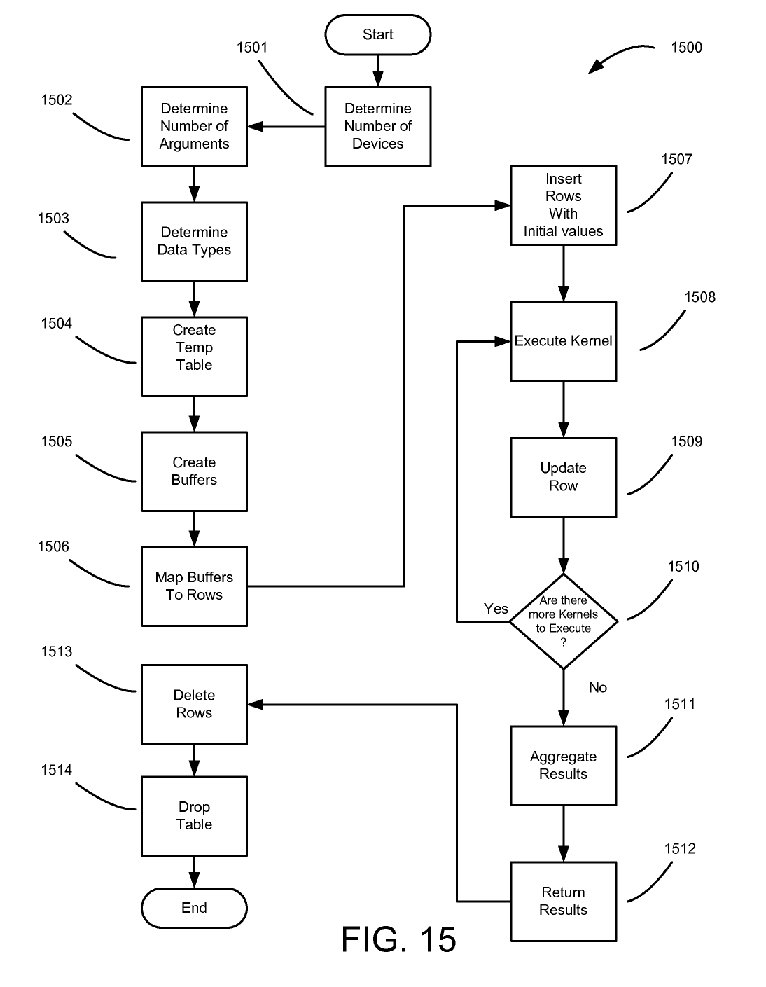

FIG. 15 illustrates a flowchart of a process 1500 using GPU Kernel argument buffers as columns in database rows or records in order to combine results from multiples devices or multiple Kernel executions. GPU and Many-Core devices are currently constrained in RAM size; they typically have less RAM than conventional CPU based systems. Database system 100 can easily store more data than available RAM. A system may include multiple independent GPU Many Core devices. With multiple devices or a large sized problem, it is necessary to split the problem into smaller pieces and execute the pieces multiple times or use multiple devices. To support multiple devices or multiple executions it is necessary to combine the results from a single device or individual executions with other results into a single results set. This is accomplished by using databases rows or records for storage and using a database function like Sum or a Stored Procedure to combine the results. The GPU Many Core program buffers are mapped so as to appear as columns in a database table. One database row is used for each device and one column represents one GPU Device buffer. These Device buffers are allocated in the Retained Memory Pool, so as to persist across multiple Kernel executions. They are transferred between the host environment and the GPU as Kernel parameter buffers. When the GPU Kernel updates these buffers they are effectively updating database rows or records. These interim results from multiple executions can then be combined using standard database functions and operations. The combined results are returned to the originating database query.

The process 1500 includes steps 1501-1514. A step 1501 determines a number of devices that the queries are able to use for execution. A step 1502 determines a number of Stored Procedure or Kernel arguments, a step 1503 determines the data types of the Kernel Argument types to be used to create the retained buffers, a step 1504 creates a temporary database table or record, a step 1505 creates the Kernel buffers, a step 1506 maps the buffer to the database rows, a step 1507 inserts the rows into the database with initial values, a step 1508 executes the kernels as part of the database query or update command, a step 1509 updates the database base row based on the updated Kernel buffer, and a step 1510 determines whether there are more Kernels to execute. When yes, process 1500 returns to step 1508 and when no, process 1500 advances to a step 1511. Step 1511 aggregates and combines the results from multiple rows, a step 1512 returns the results to the original query, a step 1513 deletes the rows and de-allocates the Kernel buffers, and a step 1514 drops the table removing it from the database system.

The system and methods above has been described in general terms as an aid to understanding details of preferred embodiments of the present invention. In the description herein, numerous specific details are provided, such as examples of components and/or methods, to provide a thorough understanding of embodiments of the present invention of using GPU and Many-Core programming as database Stored Procedure language. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

The system, method, and computer-program product above has been described in the preferred embodiment including a suitably programmed general purpose computer, real, virtual, and/or cloud-based, including a processing unit executing instructions read from a memory, controlled using one more user interfaces, with the memory being local or remote to the system, and in some cases a wired/wireless interconnection with other computing systems for the access/sharing/aggregation of data. In some embodiments, the devices communicate via a peer-to-peer communications system in addition to or in lieu of Server/Client communications.

The system, method, and computer program product, described in this application may, of course, be embodied in hardware; e.g., within or coupled to a Central Processing Unit (“CPU”), microprocessor, microcontroller, System on Chip (“SOC”), or any other programmable device. Additionally, the system, method, and computer program product may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, nanoprocessing, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, and computer program product embodied in software may be included in a semiconductor intellectual property core (e.g., embodied in HDL) and transformed to hardware in the production of integrated circuits. Additionally, a system, method, and computer program product as described herein may be embodied as a combination of hardware and software.

One of the preferred implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, and the like. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, transmit, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” and the like. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A GPU accelerated database system for a database storing a database table, comprising:
an application producing a parallelized query for the database;
a database server executing said parallelized query against the database;
a stored procedure function manager that executes a stored procedure;
one or more GPU/Many-Core devices, each GPU/Many-Core device including a compute unit having one or more arithmetic logic units executing one or more Kernel instructions and a memory storing data and variables; and
a GPU/Many-Core host computationally communicated to said one or more GPU/Many-Core devices, said GPU/Many-Core host creating a computing environment that defines said one or more GPU/Many-Core devices, obtaining a GPU Kernel code executable, and executing said GPU Kernel code executable using said one or more GPU/Many-Core devices;
wherein said parallelized query includes a particular stored procedure executed by said stored procedure function manager;
wherein said particular stored procedure includes said GPU Kernel code executable; and
wherein said stored procedure function manager initiates said executing of said GPU Kernel code executable by said GPU/Many-Core host in response to said particular stored procedure.

2. A computer-implemented method, comprising:
a) creating a GPU/Many-Core environment inside a database server;
b) obtaining GPU/Many-Core Kernel programs for a plurality of GPU/Many-Core devices executable by said database server as stored procedures;
c) querying said GPU/Many-Core environment to obtain a GPU/Many-Core characterization; and
d) presenting said GPU/Many-Core environment as a data structure within said database server.

3. The method of claim 2 wherein said data structure within said database server includes a database system catalog table.

4. The method of claim 2 wherein said querying step c) includes accessing said GPU/Many-Core environment via a database API calls.

5. The method of claim 4 wherein said GPU/Many-Core environment is updated/selected using a database API call or a database update command.

6. The method of claim 2 wherein said GPU/Many-Core environment includes a memory allocation, further comprising:
managing said memory allocation by having distinct memory pools for said GPU/Many Core environment, said plurality of GPU/Many-Core devices, one or more GPU/Many-Core executables, and a plurality of GPU/Many-Core program data.

7. A computer-implemented method for programming one or more GPU/Many-Core devices, the method comprising:
a) hosting a GPU/Many-Core program Kernel code executable inside a database available to the database as a stored procedure; and
b) executing said GPU/Many-Core program Kernel code executable on the one or more GPU/Many-Core devices by calling a query against said database using a database server and said stored procedure.

8. A computer-implemented method for GPU acceleration of a database system, the method comprising:
a) executing a parallelized query against a database using a database server, said parallelized query including an operation using a particular stored procedure available to said database server that includes a GPU/Many-Core Kernel executable; and
b) executing said particular stored procedure on one or more GPU/Many-Core devices.

9. The computer-implemented method of claim 8 wherein said executing step b) includes instantiation of a plurality of execution threads for said one or more GPU/Many-Core devices and wherein said GPU/Many-Core Kernel executable includes one or more arguments, each argument having an array size, further comprising:
c) determining a number N parallel threads for said plurality of execution threads by parametric use of said array sizes.

10. The computer-implemented method of claim 9 wherein said determining step c) includes applying a linear transformation, including scaling and translation, to said array sizes.

11. The computer-implemented method of claim 9 wherein said number N parallel threads each include a thread array size, the method further comprising:
d) determining an output parameter size used for a GPU/Many-Core programming environment used by said plurality of GPU/Many-Core devices by parametric use of said thread array sizes.

12. The computer-implemented method of claim 11 wherein said determining step d) includes applying a linear transformation, including scaling and translation, to said thread array sizes.

13. The computer-implemented method of claim 9 wherein a number M of said plurality of GPU/Many-Core devices accessed by said executing step b) is responsive to said number N parallel threads and wherein said number N is responsive to a mode setting of said database server.

14. The computer-implemented method of claim 13 wherein said mode setting is selected from one of a fixed mode, a kernel mode, and a dynamic mode.

15. The computer-implemented method of claim 13 wherein said mode setting is specified via an API call used from said database server.

16. The computer-implemented method of claim 8 wherein said executing step b) includes c) producing a return result from said one or more GPU/Many-Core devices.

17. The computer-implemented method of claim 16 wherein said particular stored procedure includes a reduction operation and wherein said return result includes a single element of an array, the method further comprising:
d) mapping said single element from said reduction operation to a scalar value.

18. The computer-implemented method of claim 8 wherein each said GPU/Many-Core Kernel executable includes an argument buffer represented as a data structure within said database.

19. The computer-implemented method of claim 18 wherein said executing step b) includes
c) producing a return result from each said one or more GPU/Many-Core devices, and wherein each said return result is mapped to a particular one argument buffer.

20. The computer-implemented method of claim 19 further comprising:
d) combining said return results from said one or more GPU/Many-Core devices by operation on said data structures within said database.

21. A computer program product comprising a computer readable medium carrying program instructions for GPU acceleration of a database system when executed using a computing system, the executed program instructions executing a method, the method comprising:
a) executing a parallelized query against a database using a database server, said parallelized query including an operation using a particular stored procedure available to said database server that includes a GPU/Many-Core Kernel executable; and
b) executing said particular stored procedure on one or more GPU/Many-Core devices.
